(19) United States
(12) Patent Application Publication
(10) Pub. No.: US 2024/0379980 A1
(43) Pub. Date: Nov. 14, 2024

(54) AIR SUPPLY DEVICE OF FUEL CELL SYSTEMS

(71) Applicant: FORD GLOBAL TECHNOLOGIES, LLC, Deaborn, MI (US)

(72) Inventors: Guenter Hans GROSCH, Vettweiss (DE); Krystian DYLONG, Cologne (DE); Rainer KIEHN, Frechen (DE); Georg LOUVEN, Neuwied (DE)

(73) Assignee: FORD GLOBAL TECHNOLOGIES, LLC, Dearborn, MI (US)

(21) Appl. No.: 18/657,206

(22) Filed: May 7, 2024

(30) Foreign Application Priority Data
May 9, 2023 (DE) 102023112116.2

(51) Int. Cl. H01M 8/04746; H01M 8/04082

(52) U.S. Cl. CPC H01M 8/04776; H01M 8/04201; H01M 8/04753; H01M 2250/20

(57) ABSTRACT

An air supply device for a fuel cell system having an electrically driven flow compressor with an electric motor driving a shaft includes first and second compressors independently controllably coupled to the shaft by respective coupling devices. The first compressor has a feed line from which a feed bypass line branches off at a branch point and opens to an inlet side of the second compressor with a control element arranged in the branch, and with the first compressor having a compressor outlet that opens into a compressor outlet line that is connectable to the feed bypass line via a connection line controllable by means of a control unit. The compressors may be operated individually or together with flow arranged in parallel or in sequence when operating together, and may have different operating maps and mass airflow capabilities.

### CROSS-REFERENCE TO RELATED APPLICATIONS

This application claims foreign priority benefits under 35 U.S.C. § 119 (a)-(d) to DE Application 10 2023 112 116.2 filed May 9, 2023, which is hereby incorporated by reference in its entirety.

### TECHNICAL FIELD

This application relates to an air supply device of a fuel cell system.

### BACKGROUND

Fuel cell systems, which may have one or more stacks of fuel cells, are known per se, with hydrogen being fed to the anode side and usually air, that is to say ambient air, being fed to the cathode side. This is performed using air supply devices, which may have different designs.

Document DE102017220855A1, which is also published as WO2019101593A1 and U.S. Pat. No. 11,473,583B2, discloses a turbocompressor, in particular for a fuel cell system. The turbocompressor has a first compressor unit and a second compressor unit. The first compressor unit comprises a first compressor arranged on a first shaft drivable by a drive unit. The second compressor unit comprises a second compressor and an exhaust gas turbine. The second compressor and the exhaust gas turbine are arranged on a second shaft.

Document DE102010035725A1 relates to a supercharging device for an energy conversion device, in particular a fuel cell, of a car, comprising a rotor mounted rotatably on a housing of the supercharging device, said rotor comprising a shaft and at least two compressor wheels, which are connected to the shaft for conjoint rotation, have respective wheel back parts facing away from the respective compressor wheel inlets, and by means of which a medium to be fed to the energy conversion device, in particular air, can be compressed, with the wheel back parts of the compressor wheel being adapted to one another, whereby respective, opposite forces resulting from respective compressor wheel outlet pressures impressed on the wheel back parts are to be at least substantially counterbalanced.

Document DE102020206162A1 relates to an air supply device for fuel cell systems comprising a flow compressor and an electric drive motor for the flow compressor, with the flow compressor having two compressor wheels, which are substantially symmetrical and, together with the electric drive motor arranged between them, are arranged on a common shaft. The two compressor wheels are connected on the pressure side to two systems not permanently pneumatically connected. In addition, a fuel cell system is described which uses an air supply device of this kind.

Document DE102021201972A1 discloses a supercharging device for a fuel cell, having a driveable drive shaft, which is mounted rotatably about a drive axis, and a compressor wheel mounted on a compressor shaft rotatably about a compressor rotation axis for compressing ambient air for the fuel cell, with the compressor shaft and the drive shaft being separated from one another by a membrane, and with a magnet arrangement being mounted on the compressor shaft and facing a magnet arrangement arranged on the drive shaft, with the magnet arrangements acting on one another through the membrane, and with the drive shaft being mounted rotatably relative to a housing via a lubricated bearing.

Document DE102021204650A1 relates to an air supply device for fuel cell systems with two-stage compression. For supply of fuel cell stacks interconnected electrically in parallel, a turbocompressor is provided for each of the fuel cell stacks and is mechanically coupled to an exhaust air turbine for the corresponding fuel cell stack, with at least one electrically driven flow compressor being provided in front of the corresponding turbocompressor in the flow direction of the compressed air and in each case supplying air to at least two of the turbocompressors in parallel. A fuel cell system comprising at least two fuel cell stacks comprises an air supply of this kind and is intended to be suitable for use, for example, in a vehicle, in particular in a commercial vehicle.

Depending on the operating point of the fuel cell system, a different air volume is required, that is to say a different air mass flow optionally with different pressure value, so that the optimal airflow cannot be generated at all operating points using the conventional air supply devices. Normally, in fuel cell systems the air supply device is started, with the fuel cell system initially being bypassed until the necessary rotary speed is reached. An air supply device that delivers sufficient supply air for all operating points is normally quite large, that is to say oversized so to speak, and therefore has a great inertia, so that the compressor naturally needs longer to be brought to the necessary rotary speed. Once the necessary rotary speed is reached, the bypass is closed and supply air conveyed into the fuel cell system. As mentioned, large air supply devices, by means of which all operating points can be covered, have a high moment of inertia and corresponding delay in reaching desired operating speed. They also require more electrical power. The time for starting the fuel cell system is in turn dependent on the time required for the air supply device to be brought to the necessary rotary speed.

### SUMMARY

It should be noted that the features and measures described individually in the following description can be combined with one another in any technically feasible way and show further embodiments of the invention. The description additionally characterizes and specifies the invention in particular in conjunction with the figures.

Various embodiments according to the present disclosure optimize an air supply device for fuel cell systems by simple means. In one or more embodiments, an air supply device for a fuel cell system having an electrically driven flow compressor with an electric motor driving a shaft that includes a first compressor and a further compressor. Each compressor is connected to the shaft or separated therefrom by means of its own coupling device, with the first compressor having a feed line, from which a feed bypass line branches off at a branch point and opens out on the inlet side in the further compressor, with a control element being arranged at the branch point, and with the first compressor having a compressor outlet that opens out into a compressor outlet line that is selectively connected to the feed bypass line or separated therefrom via a connection line controllable by means of a control unit.

Embodiments may also include an air supply device for fuel cell systems of vehicles that can be operated fully variably as either an electric single/individual compressor or double compressor in series or parallel, depending on the operating range in which the fuel cell system is operated. The two compressors each have associated compressor outlet lines via which compressed ambient air is fed or supplied to the fuel cell system.

The power (air mass flow) conveyed in each case for both compressors is controlled by the two coupling devices, which can be embodied as electric slip couplings and/or as magnetic couplings, and also by means of the control elements and/or control units. The air supply device, which can also be referred to as a charging apparatus, is thus operated as efficiently as possible at all operating points. The control elements and control units can preferably be embodied as flap valves, which are continuously controllable between a fully locked and fully released position, that is to say a maximum position in each case. The control of the coupling devices of the control elements and/or control units but also of the driving electric motor is dependent on the operating point of the fuel cell system and can be effected via a central control unit. This can be implemented or stored in the central control apparatus of the vehicle. The various components are actuatable in particular wirelessly. Of course, corresponding bearing measures are provided.

The compressors may be operated individually or in each case in combination with the other compressor. The compressors may have different designs, that is to say may be different in respect of their characteristic map. The first compressor may be embodied as the smaller compressor of the two, that is to say with its characteristic map can generate a smaller air mass flow (mass airflow) than the further compressor, the characteristic map of which can be designed correspondingly to generate a greater air mass flow (mass airflow).

At heavy-load operating points, only the first compressor may thus be activated, with the coupling device of the further compressor being open. This has the advantage that the lag or delay of the first compressor to reach desired operating speed is reduced on account of the lower mass and the smaller inertia. The further compressor can, as already stated, have a different mapping, that is to say a different characteristic map, so that it can be activated at operating points that require a higher mass flow. The characteristic maps of the two compressors can overlap in part. For example, it is within the scope of the disclosure to start up only the first compressor or only the further compressor.

The compressors of the air supply device can be operated in series in an expedient embodiment, with either the first compressor or the further compressor being connected to the shaft, with a switchover from the first compressor to the further compressor being carried out only when the further compressor has reached a rotary speed that corresponds to the rotary speed of the first compressor, with the coupling device of the first compressor then being opened. In particular, it is possible to start up the two compressors in succession as necessary, by closing the corresponding coupling device, with the coupling device of the other compressor, however, then not being opened immediately, which would cause said other compressor to be taken out of service immediately. Rather, a controlled switchover is performed. If a switch is made between the compressors, the coupling device of the further compressor is closed, so that the coupling devices are both temporarily closed until the further compressor has reached the same rotary speed as the first compressor, then the coupling device of the first compressor opens, so that the latter is separated from the shaft. At this time the control element also opens at the branch point to the feed bypass line, so that the further compressor feeds the feed air to the fuel cell system in accordance with the present operating point. Since the first compressor is separated from the shaft, no air mass flow is conveyed by it. The ambient air is diverted through the sole feed line flowing into the feed bypass line and is only conveyed or compressed via the further compressor.

The compressors of the air supply device can be operated in parallel in a target-oriented configuration, with the corresponding coupling device being closed, and with the control element at the branch point to the feed bypass line being opened whilst the control valve in the connection line is closed. In the event of a necessary high mass flow, both coupling devices are thus closed in a target-oriented manner and the control units and control elements are set to a parallel circuit that allows the greatest mass flow at lower pressure. Here, the ambient air flows through the sole feed line to the first compressor and via the opened branch point into the feed bypass line to the further compressor.

In yet another embodiment the compressors of the air supply device can be operated in series, in which both coupling devices are closed, with the control element being closed at the branch point to the feed bypass line whilst the control unit in the connection line is opened. Both compressors are thus connected to the shaft, but passed through by the flow in succession. At operating points that require a high pressure with low air mass flow, both coupling devices are thus closed, however, the control elements and control units are switched over to a sequential setting in series, so that the air mass flow is lower at higher pressure.

The air supply device can be used for air supply with ambient air or other media of a fuel cell system. Also in fuel cell systems having two or more stacks, the air supply device has the advantage that it can provide the required air mass flow with the necessary pressure value at any operating point, even when only one stack is in operation.

Various embodiments according to the disclosure provide an air supply device for a fuel cell system, which provides a fully variable supercharging also for multi-stack systems, a reduced reaction time, and increased efficiency alongside a lower electrical power requirement. The respective characteristic maps of the various compressors can additionally be adjusted optimally to the requirements of the fuel cell system, so that, in an ideal embodiment, an optimized overall characteristic map is achieved.

Further advantageous details and effects will be explained in greater detail hereinafter on the basis of representative embodiments shown in the figures, in which

### BRIEF DESCRIPTION OF THE DRAWINGS

FIG. 1 shows an air supply device for a fuel cell system in a first operating state with a first compressor feeding the output;

FIG. 2 shows the air supply device of FIG. 1 in a second operating state with the second compressor feeding the output;

FIG. 3 shows the air supply device of FIG. 1 in a third operating state with the first and second compressors operating in parallel and feeding the output; and

FIG. 4 shows the air supply device of FIG. 1 in a fourth operating state with the first and second compressors operating in series to feed the output with maximum pressure.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

As required, detailed embodiments are disclosed herein; however, it is to be understood that the disclosed embodiments are merely representative and may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the claimed subject matter.

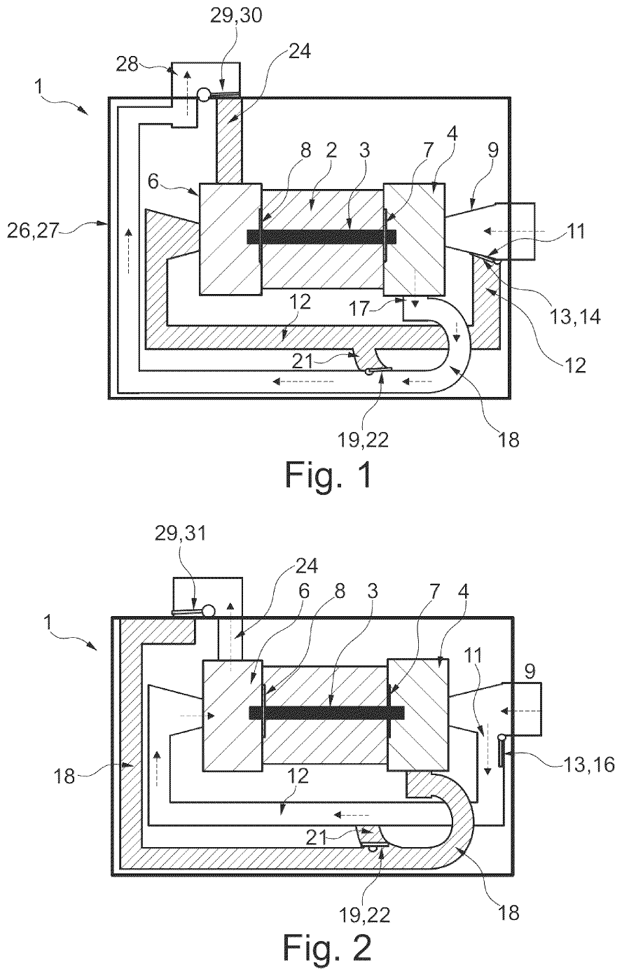

In the various figures, like parts are always provided with the same reference signs, and therefore these are generally also described only once. Airflow lines or line portions not passed through are shown hatched in FIGS. 1 to 4, with lines or line portions through which the flow passes not being hatched, but having dashed flow arrows.

FIG. 1 shows an air supply device 1 for a fuel cell system of a vehicle, in particular a passenger car or a commercial vehicle, such as a heavy goods vehicle, omnibus or the like. The fuel cell system can comprise an individual fuel cell stack or a plurality of fuel cell stacks.

The air supply device 1 has an electrically driven flow compressor 2, with an electric motor driving a shaft 3, on which there is arranged a first compressor 4 and a second or further compressor 6. The various compressors 4, 6 are each connectable, that is to say connected to the shaft 3, or separable, that is to say separated, therefrom via their own respective coupling device 7, 8. The coupling device 7 is assigned to the first compressor 4, with the coupling device 8 being assigned to the further compressor 6. The coupling devices 7, 8 can be embodied as an electric slip coupling or as a magnetic coupling.

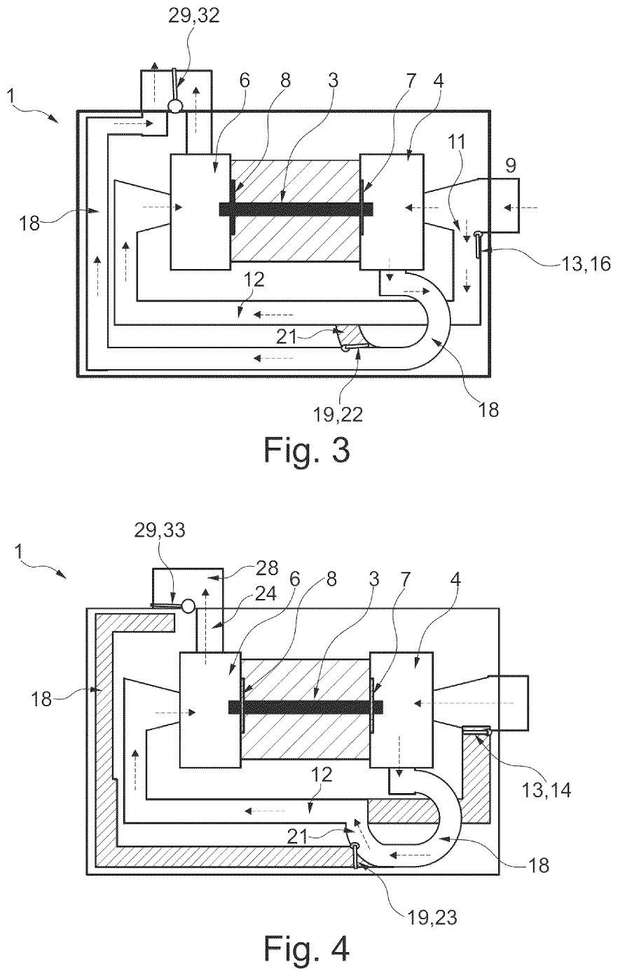

The first compressor 4 has a feed line 9, from which a feed bypass line 12 branches off at a branch point and opens out on the inlet side in the further compressor 6. A control element 13 is arranged at the branch point 11. The control element 13 can be embodied as a valve flap which is adjustable between the shut-off position 14 shown in FIG. 1, in which position the branch point 11 is closed, and a release position 16 shown in FIGS. 2 and 3. The control element 13 is adjustable between the two stated maximum positions. The first compressor 4 has a compressor output 17, which opens out into a compressor output line 18. The compressor output line is guided past the feed bypass line 12 connection-free. At the same time, the compressor output line 18 and the feed bypass line 12 have a connection, with the compressor output line 18 being connected to the feed bypass line 12 or separated therefrom via a connection line 21 controllable by means of a control unit 19. The control unit 19 can be embodied as a valve flap which is adjustable between the shown shut-off position 22, in which the connection line 21 is closed, and a release position 23 shown in FIG. 4. The control unit 19 is preferably continuously adjustable between the two stated maximum positions.

The further compressor 6, similarly to the first compressor 4, also has a compressor outlet line 24. The air supply device 1 is accommodated in a housing 26. The housing 26 offers the advantage of making the air guidance very compact and optionally providing a cooling (air, water, oil, etc.). The compressor outlet lines 18, 24 are guided out from the housing 26. The air supply device 1 can be installed in the housing 26 in a manner adapted to the fuel cell system, with the housing 26 possibly being embodied in multiple parts, optionally with at least one ceiling wall, through which the compressor output lines 18, 24 are guided. The ceiling wall can be fitted in position when the air supply device 1 is fully assembled and can be provided for NVH reasons (NVH: Noise Vibration Harshness), with the ceiling wall not being absolutely necessary. The sole feed line 9 is guided through the housing wall 27 and opens out on the inlet side into the first compressor 4. The branch point 11 is arranged inside the housing 26, with the feed bypass line 12 inside the housing 26 branching off from the feed line 9 before the feed line 9 opens out into the first compressor 4.

The compressor output line 18 of the first compressor 4 and the compressor output line 24 of the further compressor 6 are each guided out from the housing 26. The two compressor output lines 18, 24 open outside the housing 26 into a collection element 28, in which there is arranged a control means 29. The control means 29 is arranged continuously as a rotary valve in the collection element 28 and can be moved on the one hand in the direction of the compressor output line 24, on the other hand in the direction of the compressor output line 18, but also into a neutral position. The collection element 28 has a line (not shown) that continues in the direction to the fuel cell system. The control means 29 can be embodied by way of example as a rotary valve which is adjustable in the serial position 30 and 31 shown in FIGS. 1 and 2, a parallel position 32 (FIG. 3) and a maximum pressure position 33 (FIG. 4). The control means 29 prevents the flow flowing out from a particular compressor output line 18 or 24 from flowing into the other compressor output line 18 or 24, so that the flows in the respective compressor output lines 18, 24 are prevented from being impaired. In the serial position 30 according to FIG. 1, the control means 29 is arranged so as to seal the compressor output line 24 of the further compressor 6, since only the first compressor 4 is operated. In the serial position 31 according to FIG. 2, the control means 29 is arranged so as to seal the compressor output line 18 of the first compressor 4, since only the further compressor 6 is operated. In the parallel position 32, the control means 29 is arranged in the middle of the collection element 28, that is to say in the neutral position, as can be seen in FIG. 3. In the maximum pressure position 33 according to FIG. 4, the control means 29 is arranged so as to seal the compressor output line 18 of the first compressor 4. The maximum pressure position 33 can also be equated to the serial position 31. The control means 29 is preferably embodied such that the compressor output line 18 or 24 through which the flow does not pass is fully sealed, with any recognizable leaks in the application case not being present in the figures.

The control of the coupling devices 7, 8 of the control element 13, of the control unit 19, of the control means 29, but also of the driving electric motor is dependent on the operating point of the fuel cell system and can be effected via a central control apparatus. This can be implemented or stored in a central control apparatus of the vehicle. The various components are actuatable in particular wirelessly. For example, the air supply device 1 can be operated fully variably as an electric double compressor, and can be used for example as a single or double compressor, as a serial or parallel sequential compressor, depending on the operating range in which the fuel cell system is to be operated. In one embodiment, the first compressor 4 and the second compressor 6 have different characteristic maps, so that a constantly optimized air mass flow is generated at optimized pressure conditions sufficient for the particular operating point of the fuel cell system.

In the practical example of the air supply device 1 shown in FIG. 1, only the first compressor is connected to the shaft via the coupling device 7. The control element 13 is arranged in its shut-off position 14, in which the branch point 11 is closed. All of the air is fed to the first compressor 4 via the feed line 9. The coupling device 8 of the further compressor 6 is opened. Merely the first compressor 4 thus rotates, but on account of its low inertia very quickly reaches the necessary rotary speed. The compressed air is fed to the fuel cell system via the compressor output line 18 of the first compressor 4. The control unit 19 is arranged in the shut-off position 22, closing the connection line 21.

If the fuel cell system reaches an operating point at which a greater air mass flow is necessary, which the first compressor 4 cannot provide, a switch is made to the further compressor 6.

A switchover is performed here from the first compressor 4 to the further compressor 6 only when the further compressor 6 has reached a rotary speed that corresponds to the rotary speed of the first compressor 4, with the coupling device 7 of the first compressor 4 then being opened. In particular, the coupling device 7 of the first compressor 4 is thus not opened immediately, which would cause the first compressor to be taken out of service immediately. Rather, a controlled switchover is performed. If the compressors 4, 6 are switched over, the coupling device 8 of the further compressor 6 is closed, so that the coupling devices 7, 8 are both temporarily closed at the same time, until the further compressor 6 has the same rotary speed as the first compressor 4. Only then does the coupling device 7 of the first compressor 4 open, so that the latter is separated from the shaft 3. Only at this time does the control element 13 also open (release position 16) at the branch point 11 to the feed bypass line 12, so that the further compressor 6 feeds the feed air to the fuel cell system in accordance with the present operating point. Since the first compressor 4 is separated from the shaft 3, no air mass flow is conveyed by it and is only conveyed via the further compressor 6, diverted via the sole feed line 9 into the feed bypass line 12. The control unit 19 is in the shut-off position 22 and blocks the connection line 21, but leaves the compressor output line 18 continuous. This operating state, in which the air supply device 1 feeds compressed air via the further compressor 6 to the fuel cell system, is shown in FIG. 2.

If the fuel cell system requires a high air mass flow, the compressors 4 and 6 of the air supply device 1 can be easily operated in parallel. Both coupling devices 7, 8 are closed here, so that both compressors 4, 6 are driven by the electric motor via the common shaft 3. The control element 13 at the branch point 11 is arranged in its release position 16. Both compressors 4, 6 are supplied with the ambient air, with this being fed via the feed line 9 to the first compressor 4 and via the feed bypass line 12 to the further compressor 6. The control unit 19 is arranged in its shut-off position 23, blocking the connection line 21, but leaving the compressor output line 18 continuous. the compressed air of both compressors 4, 6 is thus fed to the fuel cell system with high air mass flow at low pressure. The parallel operation of the two compressors 4, 6 is shown in FIG. 3.

At a further operating point, the fuel cell system could require a low air mass flow at high pressure. This operating point is likewise operable with the air supply device 1, by closing both coupling devices 7, 8, so that both compressors 4, 6 rotate driven by the electric motor via the common shaft 3, but are passed through in succession by the ambient air. In this operating system, which is shown in FIG. 4, the control element 13 in its shut-off position 14, blocking the branch point 11. The control unit 19 is in its release position 23, releasing the connection line 21, but blocking the passage through the compressor output line 18 in sections. The compressed air exiting from the first compressor 4 is thus fed to the further compressor 6 on the input side, flowing into the feed bypass line 12, via the continuous portion of the compressor output line 18 of the first compressor 4 and the open connection 28, with the air thus being compressed a further time. The air thus compressed twice is fed to the fuel cell system via the compressor output line 24 of the further compressor 6.

Of course, the states shown in FIGS. 1 to 4 may be separately actuatable.

While representative embodiments are described above, it is not intended that these embodiments describe all possible forms of the claimed subject matter. The words used in the specification are words of description rather than limitation, and it is understood that various changes may be made without departing from the spirit and scope of the claimed subject matter. Additionally, the features of various implementing embodiments may be combined to form further embodiments that may not be explicitly illustrated or described.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An air supply device for a fuel cell system having an electrically driven flow compressor with an electric motor driving a shaft, comprising:
a first compressor controllably coupled to the shaft by a first coupling device;
a second compressor controllably coupled to the shaft by a second coupling device;
a feed line supplying ambient air to the first compressor;
a feed bypass line extending from a branch off the feed line to an inlet of the second compressor;
a control element arranged to selectively control flow through the branch to the feed bypass line; and
a first compressor outlet line extending between an outlet of the first compressor and a collection element, the first compressor outlet line selectively coupled to the feed bypass line by a control unit.

2. The air supply device of claim 1 wherein at least one of the first and second coupling devices comprises an electric slip coupling.

3. The air supply device of claim 1 wherein at least one of the first and second coupling devices comprises a magnetic coupling.

4. The air supply device of claim 1 wherein one of the first and second coupling devices comprises an electric slip coupling and one of the first and second coupling devices comprises a magnetic coupling.

5. The air supply device of claim 1 wherein the first compressor has a lower maximum air mass flow than the second compressor.

6. The air supply device of claim 1 further comprising a second compressor outlet line extending between an outlet of the second compressor and the collection element.

7. The air supply device of claim 6 wherein the collection element includes a valve having a first position blocking airflow from the outlet line of the first compressor, a second position blocking airflow from the outlet line of the second compressor, and a third position allowing airflow from both the outlet line of the first compressor and the outlet line of the second compressor.

8. The air supply device of claim 7 wherein the control unit comprises a valve flap having a first position blocking airflow between the feed bypass line and the first compressor outlet line, and a second position allowing airflow between the feed bypass line and the first compressor outlet line.

9. The air supply device of claim 8 wherein the valve flap is continuously adjustable between the first position and the second position.

10. The air supply device of claim 8 wherein the control element comprises a valve flap having a first position blocking airflow from the feed line to the branch, and a second position allowing airflow from the feed line through the branch.

11. The air supply device of claim 10 wherein the valve flap is adjustable between the first position and the second position.

12. The air supply device of claim 11 further comprising a housing, wherein the electrically driven flow compressor, the driving shaft, the first and second compressors, the feed line, the feed bypass line, the first and second compressor outlet lines, and the control element are disposed within the housing.

13. An air supply system for a fuel cell vehicle having an electrically driven flow compressor with an electric motor driving a shaft, comprising:
a housing containing:
a first compressor controllably coupled to the shaft by a first electric slip coupling;
a second compressor controllably coupled to the shaft by a second electric slip coupling, the second compressor having a higher maximum air mass flow than the first compressor;
a feed line supplying ambient air to the first compressor;
a feed bypass line extending from a branch off the feed line to an inlet of the second compressor;
a first controllable valve flap arranged to selectively control flow through the branch to the feed bypass line;
a first compressor outlet line;
a second controllable valve flap selectively fluidly coupling the feed bypass to the first compressor outlet line;
a second compressor outlet line coupled to an outlet of the second compressor;
a collection element fluidly coupled to the first compressor outlet line and the second compressor outlet line; and
a controllable rotary valve disposed within the collection element, the rotary valve having a first position blocking airflow from the first compressor outlet line, a second position blocking airflow from the second compressor outlet line, and a third position allowing airflow from both the first and second compressor outlet lines.

14. The air supply system of claim 13 wherein the first controllable valve flap includes a first position allowing flow through the branch to the feed bypass line and a second position blocking flow through the branch to the feed bypass line.

15. The air supply system of claim 14 wherein the first controllable valve flap is continuously adjustable between the first position and the second position.

16. The air supply system of claim 14 wherein the second controllable valve flap includes a first position blocking airflow between the feed bypass line and the first compressor outlet line, and a second position allowing airflow between the feed bypass line and the first compressor outlet line.

17. The air supply system of claim 16 wherein the second controllable valve flap is continuously adjustable between the first position and the second position.

18. A fuel cell vehicle having the air supply system of claim 17.
